(19) United States
(12) Patent Application Publication
(10) Pub. No.: US 2005/0160087 A1
(43) Pub. Date: Jul. 21, 2005

(54) Data extractor and method of data extraction

(75) Inventor: Masaki Nishigaki, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited

(21) Appl. No.: 11/019,127

(22) Filed: Dec. 22, 2004

Related U.S. Application Data
(63) Continuation of application No. PCT/JP02/08759, filed on Aug. 29, 2002.

(51) Int. Cl. G06F 17/30

(52) U.S. Cl. 707/3

(57) ABSTRACT

A plurality of data stored in a database is read successively. Update contents of the data are acquired as update history, if there is an update of the data in the database during a period from a start of the data extraction to an end of the data extraction. Contents of the plurality of the data extracted are overwritten with the contents at a time of the start of the data extraction, based on the update history acquired.

### BACKGROUND OF THE INVENTION

1) Field of the Invention

The present invention relates to a data extractor and a method of data extraction in which a data extraction process of reading a plurality of data stored in a database successively is performed with a short process exclusion time for the database.

2) Description of the Related Art

So far, a database in which data is managed by converging in a form that is defined in advance for a purpose of sharing, integrated management, and high independency of data has been used. Normally, the database is connected to a plurality of terminals via a network etc., and the data used by each terminal is uniformly managed. Therefore, to share the data between the plurality of terminals, each terminal may read and write desired data stored in the database.

Thus, when the database is shared by the plurality of terminals, it is necessary to perform an exclusive control to avoid double updating of the data in the database. In the data management, exclusive control prevents the plurality of terminals from accessing the same data simultaneously. In other words, when a certain terminal is accessing data stored in the database, another terminal is kept in a standby state by not allowing access to the data till the access by the first terminal is complete, thereby preventing attempts at simultaneous updating of the data. Creating a state of not allowing another terminal access to predetermined data is called acquisition of process exclusion of the data.

Conventionally, for reading a large amount of data from the database for the purpose of backup etc., it is necessary to acquire process exclusion of the entire data to be read. In such a case, an operation of reading the large amount of data from the database is called data extraction.

In backup data extraction, the contents of data at a predetermined time are read and stored. However, the time required for extraction increases based on the amount of the data. Therefore, during the data extraction, if an access to the data included in the data subjected to extraction is allowed, a part of the data subjected to extraction is updated. Moreover, a value of each data is a value at a time when the data is read, and not a value at a time when data extraction began. This may lead to an inability to acquire data at the time of data extraction. Moreover, if the data extracted are correlated, there is a risk of mismatching of correlation between the data.

Therefore, conventionally, to prevent mismatching of the data contents, the process exclusion of all the data subjected to extraction is acquired from the beginning till the end of the data extraction, and a value of each data at the starting point of data extraction is read.

However, in a conventional method of data extraction, the data subjected to extraction cannot be updated from the start of data extraction till the completion of data extraction.

Particularly, when the amount of data to be extracted is large, the process exclusion time for the data extraction is longer. Normally, a response expected for updating of the database is a few hundreds of milliseconds. However, the process exclusion time necessary for the data extraction is much more as compared to this value, and reduces the update response time of the database to a great extent.

Conversely, to secure the update response of the database, it is necessary to select a state in which the database is not being updated, to perform the data extraction, but this restricts the start of data extraction. Moreover, for a database that is always in a state in which the updating is possible at any time, the data extraction cannot be performed, and the updating needs to be stopped for enabling the data extraction.

### SUMMARY OF THE INVENTION

It is an object of the present invention to at least solve the problems in the conventional technology.

A method of data extraction according to an aspect of the present invention includes reading successively a plurality of data stored in a database; acquiring update contents of the data as update history, if there is an update of the data in the database during a period from a start of the reading to an end of the reading; and overwriting contents of the plurality of the data read with the contents at a time of the start of the reading, based on the update history acquired.

A data extractor according to another aspect of the present invention that successively reads a plurality of data stored in a database. The data extractor includes an update history acquiring unit that acquires update contents of the data as update history, if there is an update of the data in the database during a period from a start of reading of the data to an end of reading of the data; and an overwriting unit that overwrites contents of the plurality of the data read with the contents at a time of the start of the reading of the data, based on the update history acquired.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 illustrates a concept of a method of data extraction according to an embodiment;

FIG. 2 is a block diagram of a data extractor;

FIG. 3 illustrates an extraction of page A1 from a database;

FIG. 4 illustrates an extraction of page B1 from the database;

FIG. 5 illustrates an extraction of page C2 from the database;

FIG. 6 is a flowchart of a process procedure of data extraction in a data extractor;

FIG. 7 is a flowchart of a process procedure of restoring executed by a data restoring section; and

FIG. 8 is a flowchart of a process procedure of conversion to a data format executed by a format converter.

### DETAILED DESCRIPTION

Exemplary embodiments of a data extractor and a method of data extraction according to the present invention are described in detail below with reference to the accompanying drawings.

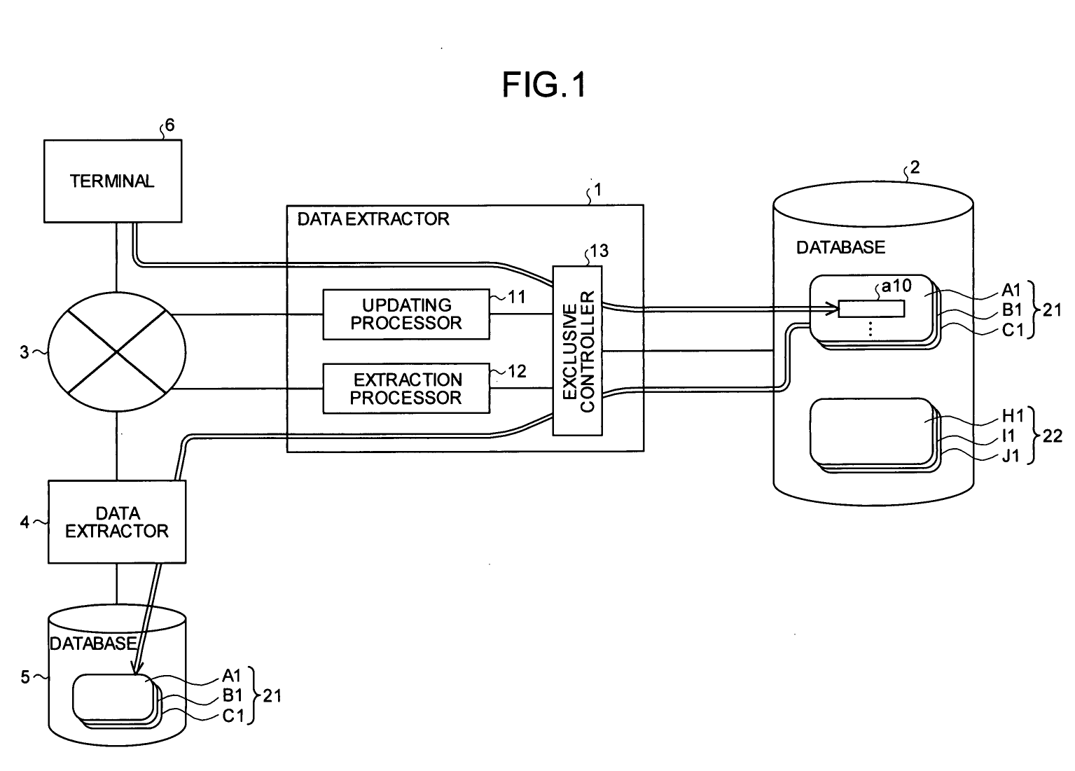

FIG. 1 illustrates a concept of a method of data extraction according to an embodiment. In FIG. 1, a database 2 is connected to a network 3 via a data extractor 1. A database 5 is connected to the network 3 via a data extractor 4. A terminal 6 is connected to the network 3.

The database 2 stores data constellations 21 and 22. The data management in the database 2 is performed using an input-output unit named as page. The data constellation 21 includes pages A1, B1, and C1, and the data constellation 22 includes pages H1, I1, and J1.

On the other hand, in the data constellations 21 and 22, the contents of data are stored in each page using a unit named as record. The input and output of data from the outside to the database is performed in units of records.

If the terminal 6 needs to update the data included in the data constellation 21 stored in the database 2, the terminal 6 accesses the data extractor 1 via the network 3. Based on the access from the terminal 6, an updating processor 11 in the data extractor 1 acquires a process exclusion of desired data through an exclusive controller 13, thereby reading and writing data. Because this data updating is performed in units of records, when the updating processor 11 accesses a certain record, the exclusive controller 13 acquires a process exclusion of a page that stores this record.

On the other hand, for extracting the data constellation 21 stored in the database 2 and storing in the database 5, a process exclusion of data extracted by an extraction processor 12 through the exclusive controller 13 is acquired, and the data extraction is started. In this case, the extraction processor 12 acquires process exclusion one after another for the pages A1, B1, and C1, which are included in the data constellation 21.

In other words, the extraction processor 12, first acquires the process exclusion only for the page A1, terminates process exclusion of the page A1 after reading records on the page A1, and then acquires a process exclusion for the page B1.

Thus, acquiring the process exclusion only for the page that is to be read, and allowing the access to the other pages enables the updating of the data constellation 21 during the data extraction.

To prevent the mismatching in data extracted due to the updating that is performed during the data extraction, the data extractor 1 monitors the updating operation performed by the updating processor 11, and stores the changes as updated log data, when the database is updated. The data extractor 1 uses the updated log data to revert the data extracted to a value at a starting point of the extraction, and can thus acquire a value of the data constellation 21 at the starting point of the extraction.

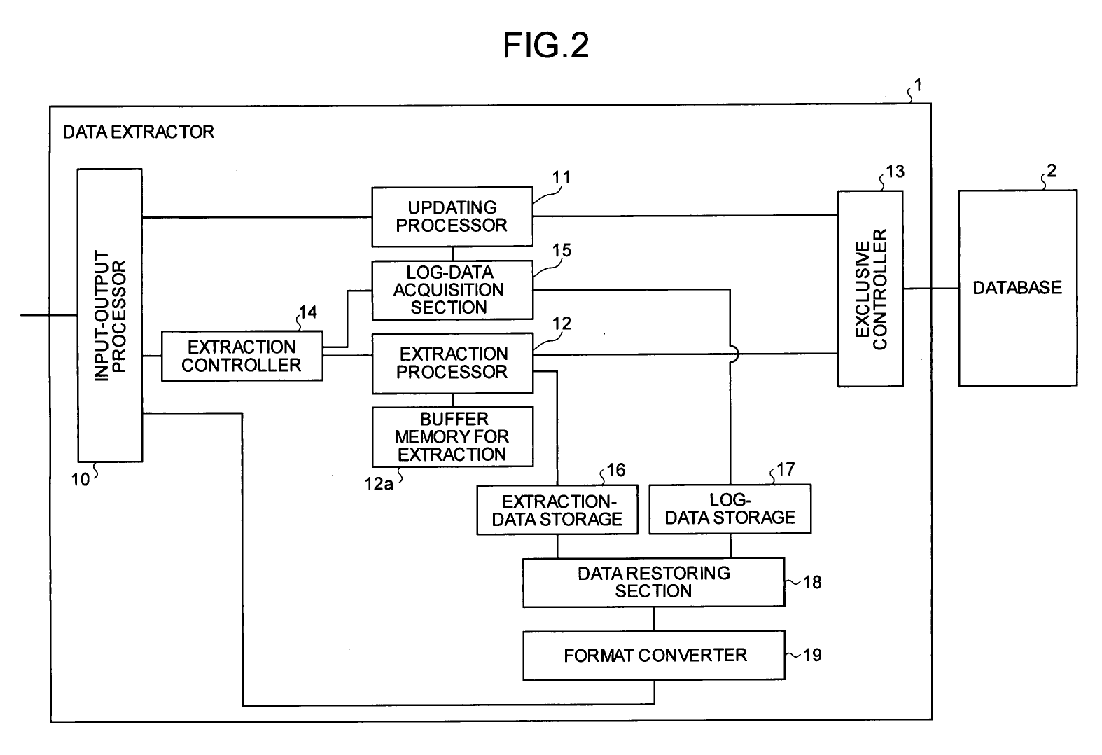

Following is a description of a concrete structure of the data extractor 1. FIG. 2 is a block diagram of a data extractor. In addition to the updating processor 11, the extraction processor 12, and the exclusive controller 13 shown in FIG. 1, the data extractor 1 includes an input-output processor 10, an extraction controller 14, a log-data acquisition section 15, an extraction-data storage 16, a log-data storage 17, a data restoring section 18, and a format converter 19. The extraction processor 12 includes a buffer memory for extraction 12a.

The input-output processor 10 receives an access to the database 2 via the network 3. Upon receiving an access requesting updating of data stored in the database 2, the input-output processor 10 outputs the access received to the updating processor 11. Moreover, upon receiving an access requesting the extraction of data stored in the database 2, the input-output processor 10 outputs the access received to the extraction controller 14.

When the input-output processor 10 receives an access requesting updating of data, the updating processor 11 acquires process exclusion for the page that stores the data to be updated, and updates the data.

When the input-output processor 10 receives an access requesting the data extraction, the extraction controller 14 outputs a command instructing start of acquisition of the updated log data to the log-data acquisition section 15, and a command instructing the start of data extraction to the extraction processor 12.

The extraction processor 12 receives the command from the extraction controller 14, and starts the extraction of the data from the database 2. At this time, the extraction processor 12 performs data extraction by acquiring the process exclusion one after another for the pages in the data constellation that is extracted. Further, the extraction processor 12 extracts the page as a page image, and stores the page in the extraction-data storage 16.

The log-data acquisition section 15 receives the command from the extraction controller 14, and starts monitoring the updating processor 11. During the monitoring, if the updating processor 11 updates the database 2, the log-data acquisition section 15 stores the contents of updating by the updating processor 11 as updated log data in the log-data storage 17. Updated data and the contents of updating are recorded in the updated log data.

The data restoring section 18 restores the data based on the page image stored in the extraction-data storage 16 and the updated log data stored in the log-data storage 17. Restoration of data is a process of reverting contents of the page image to the contents at the starting point of the extraction using the contents of the updated log data, when the contents changed after the start of extraction are included in the page image extracted. The data restoring section 18 outputs the page image restored to the format converter 19.

The format converter 19 changes the data included in the page image received from the data restoring section 18 to a desired format according to the requirement, and outputs the changed data to the input-output processor 10. The input and the output within the database 2 are in units of pages. However, it is desirable that the handling of the data included in the page extracted be performed in a generalized format. Therefore, the data is converted by the format converter 19, before outputting to the network 3 via the input-output processor 10.

Following is a description of the buffer memory for extraction 12a. The buffer memory for extraction 12a that is connected to the extraction processor 12, functions as a temporary storage during extracting the page image from the database 2. In other words, while reading the page image from the database 2, the extraction processor 12 acquires the process exclusion of the page to be extracted, and at a point of time when the page image read is stored in the buffer memory for extraction 12a, the extraction processor 12 judges that the reading of the page image is complete, and then terminates the process exclusion for that page.

Thus, the process exclusion is terminated at the point of time when the page image read is stored in the buffer memory for extraction 12a, and the page image stored in the buffer memory for extraction 12a is stored in the extraction-data storage 16 after terminating the process exclusion. Therefore, the time required for the process exclusion for reading each page is determined by capacity and speed of reading and writing of the buffer memory for extraction 12a.

Therefore, it is possible to read and write at a high speed, and by providing the buffer memory for extraction having sufficient capacity, the time for the process exclusion of each page reduces.

For high speed processing by the buffer memory for extraction 12a, it is desirable to provide a database buffer memory in the database. Providing the database buffer memory in the database, and storing the necessary data for the extraction and updating of the data in the database buffer memory in advance, helps to further reduce the time for process exclusion necessary at the time of updating and extraction of the data.

Similarly, the updating processor 11 and the extraction processor 12 can be realized as independent processors. In the data extraction process, a large amount of data is read continuously, the processor operates throughout the data extraction. Therefore, if the data extraction and updating are realized by the same processor, the data extraction consumes the processing capacity of the processor, and reduces the processing capacity that can be used for the updating, thereby reducing the processing speed of updating. Hence, realizing the updating processor 11 and the extraction processor 12 as independent processors can secure the processing capacity used for updating, and avoids a decrease in the processing speed during updating.

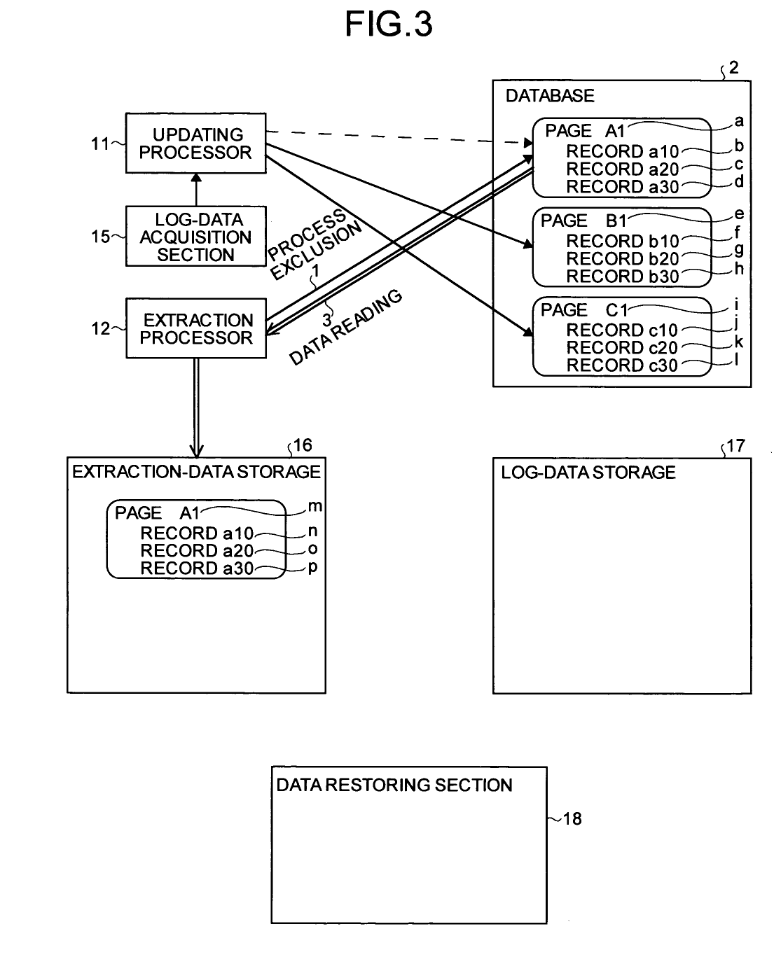

Next, the data extraction performed by the data extractor 1 is described further with reference to FIGS. 3 to 5. When the data extractor 1 reads the pages A1, B1, and C1 from the database 2, first, the log-data acquisition section 15 starts monitoring the updating processor 11, and then the extraction processor 12 acquires the process exclusion for the page A1 in the database 2 (see FIG. 3). Therefore, the updating processor 11 cannot access the page A1. On the other hand, because the extraction processor 12 has not acquired the process exclusion for the pages B1 and C1, the updating processor 11 can freely access the pages B1 and C1.

As shown in FIG. 3, the page A1 stores records a10, a20, and a30. The page B1 stores records b10, b20, and b30, and the page C1 stores records c10, c20, and c30. Upon reading the page A1 and storing it in the extraction-data storage 16, the extraction processor 12 terminates process exclusion for the page A1 in the database 2.

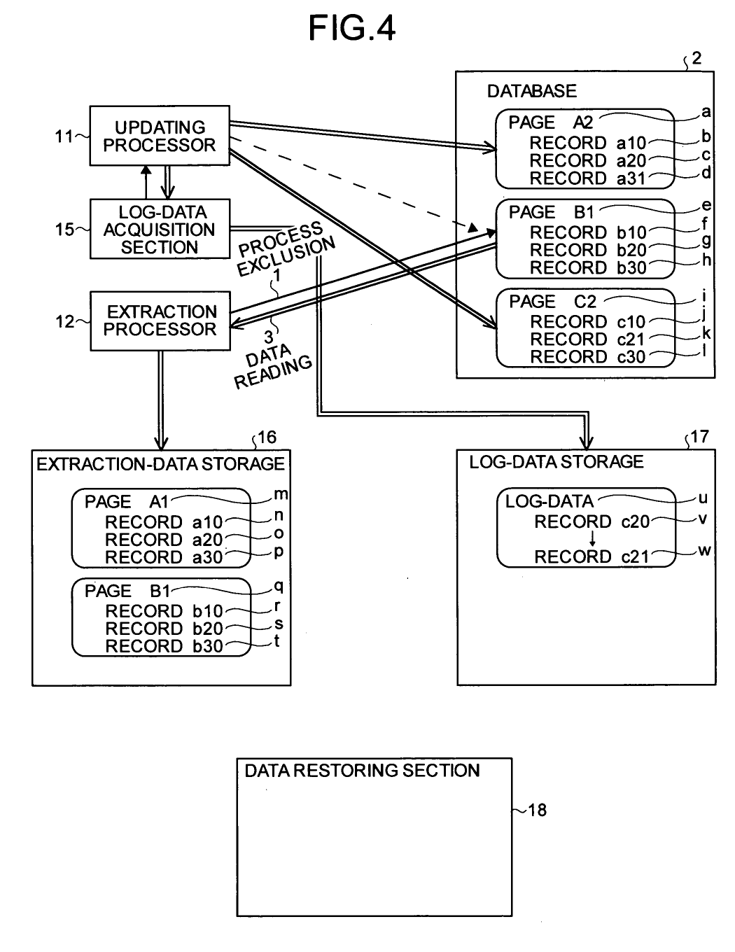

After the extraction of the page A1 is complete, the extraction processor 12 acquires the process exclusion for the page B1 (see FIG. 4). Therefore, the updating processor 11 cannot access the page B1. On the other hand, because the extraction processor 12 has not acquired the process exclusion for the pages A1 and C1, the updating processor 11 can access the pages A1 and C1 freely.

As shown in FIG. 4, upon acquiring the process exclusion for the page B1, the extraction processor 12 reads the page B1, and stores it in the extraction-data storage 16. While the extraction processor 12 extracts the page B1, the updating processor 11 can update another page. In this case, the updating processor 11 rewrites the record a30 of the page A1 to a record a31, thus changing the page A1 to a page A2, and rewrites the record c20 of the page C1 to a record c21, thus changing the page C1 to a page C2.

When the updating processor 11 has updated the records, the log-data acquisition section 15 creates updated log data, and stores the updated log data in the log-data storage 17. In FIG. 4, information indicating that the record c20 has been rewritten as the record c21 is stored as the updated log data. Moreover, information for specifying the record updated is added to the updated log data, as per requirement.

In FIG. 4, the log-data acquisition section 15 acquires log-data related to the page C2, and stores it in the log-data storage 17, but does not acquire log-data related to the page A2. This is because the updated log data of the page A1 updated to the page A2 is not required, because the extraction processor 12 has already completed the extraction of the page A1.

Upon reading the page B1 and storing in the extraction-data storage 16, the extraction processor 12 cancels the process exclusion for the page B1 in the database 2.

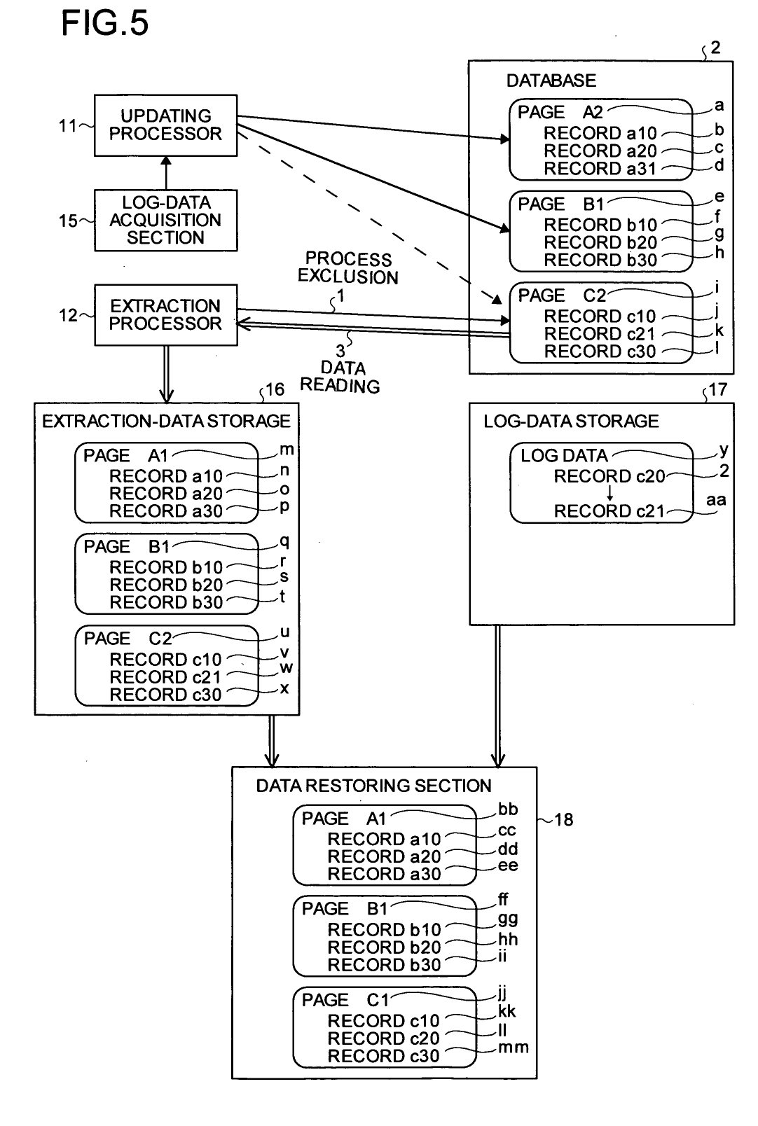

After the extraction of the page B1 is complete, the extraction processor 12 acquires the process exclusion for the page C2 (see FIG. 5). Therefore, the updating processor 11 cannot access the page C2. On the other hand, because the extraction processor 12 has not acquired the process exclusion for the pages A2 and B1, the updating processor 11 can access the pages A2 and B1 freely. In this case, the page C2 that is read by the extraction processor 12 has been updated from the page C1 by the updating processor 11. However, the extraction processor 12 reads the updated page C2 as it is, and stores in the extraction-data storage 16. Therefore, the page C2 that is stored in the extraction-data storage 16 includes a record c21, because the updating processor 11 updated the record.

Based on the updated log data stored in the log-data storage 17, the data restoring section 18 restores the page that is stored in the extraction-data storage 16. In FIG. 5, the log-data storage 17 stores information indicating that the record c20 has been updated to the record c21. Therefore, the data restoring section 18 detects a page with the record c21 from the pages in the extraction-data storage 16. In other words, the data restoring section 18 detects the page C2 and creates the page C1 by changing the record c21 to the record c20.

Thus, by restoring the page corresponding to the updated log data stored in the log-data storage 17, the data restoring section 18 can obtain the pages A1, B1, and C1 at a point of time when the data extraction started.

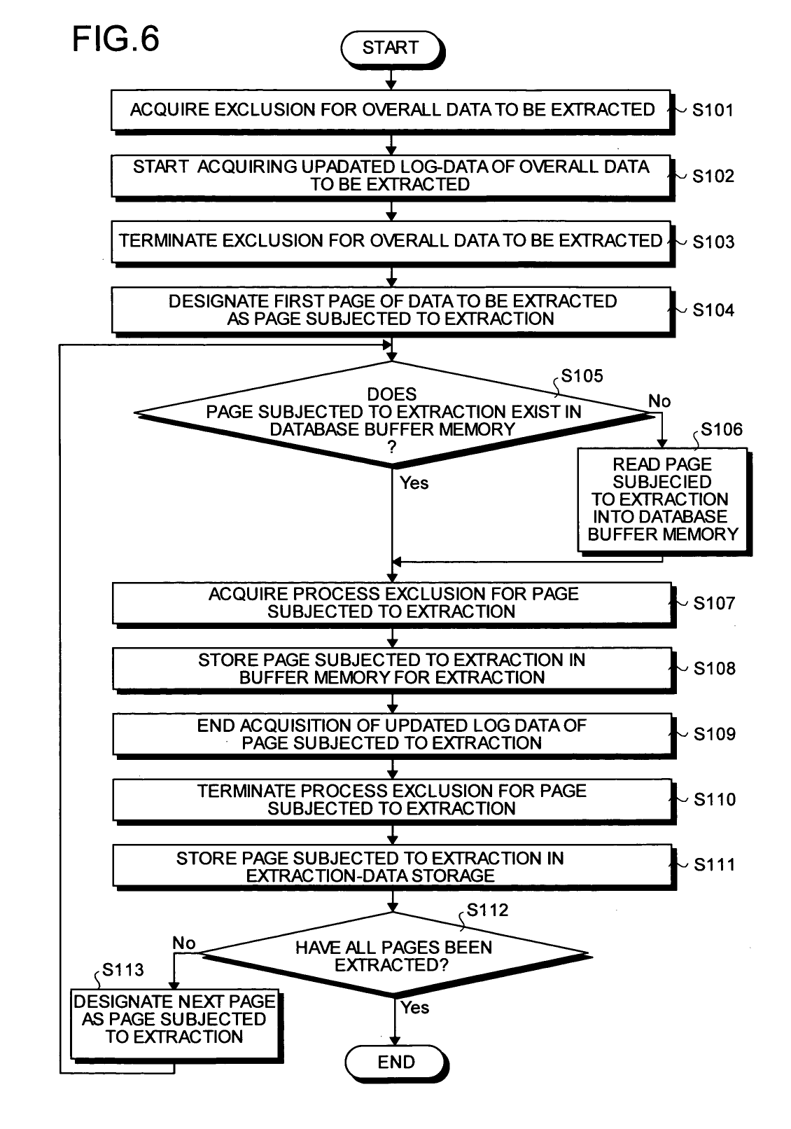

Next, an operation of data extraction in the data extractor is described in detail with reference to FIG. 6. To start with, the extraction processor 12 acquires process exclusion for overall data to be extracted (step S101). Further, the extraction controller 14 transmits a command to the log-data acquisition section 15 instructing to start acquisition of the updated log data, and starts acquiring the updated log data (step S102). Then, the extraction processor 12 terminates the process exclusion for the overall data to be extracted (step S103).

In this case, the acquisition of the updated log data starts after the extraction processor 12 acquires the process exclusion for the overall data to be extracted. This is because, if an operation of updating the data and the start of acquisition of the updated log data occur simultaneously, the updating of data taking place while the starting of acquisition of the updated log data is not affected during the restoration, and there is a mismatching of data contents.

Because the operation of transmitting the command instructing to start the acquisition of the updated log data to the log-data acquisition section 15 can be performed in a very short time, the process exclusion for the overall data to be extracted takes a very short time, and does not affect the process of data updating.

Further, the extraction processor 12 designates a first page of the data to be extracted as a page subjected to extraction (step S104). The database 2 determines whether the page subjected to extraction exists in the database buffer memory or not (step S105). If the database 2 has not stored the page subjected to extraction in the database buffer memory, i.e. if an image of the page subjected to extraction does not exist in the database buffer memory (No at step S105), the database 2 reads the page subjected to extraction into the database buffer memory (step S106).

If the image of the page subjected to extraction exists in the database buffer memory (Yes at step S105), or after reading the page subjected to extraction into the database buffer memory (step S106), the extraction processor 12 acquires the process exclusion for the page subjected to extraction (step S107). Then, the extraction processor 12 reads the page subjected to extraction, and stores it in the buffer memory for extraction 12a (step S108).

After step S108, the extraction controller 14 ends the acquisition of the updated log data (step S109), and then the extraction processor 12 terminates the process exclusion for the page subjected to extraction (step S110). Moreover, the extraction processor 12 appropriately stores the page subjected to extraction that is stored in the buffer memory for extraction 12a, into the extraction-data storage 16 (step S111).

Further, the extraction processor 12 determines whether all pages of data to be extracted have been read (step S112). If there is a page that has not been read yet (No at step S112), the extraction processor 12 designates the next page as the page subjected to extraction (step S113), and the process returns to step S105. Thus, all pages in the data to be extracted are read one by one, and when all the pages have been read (Yes at step S112), the data extraction ends.

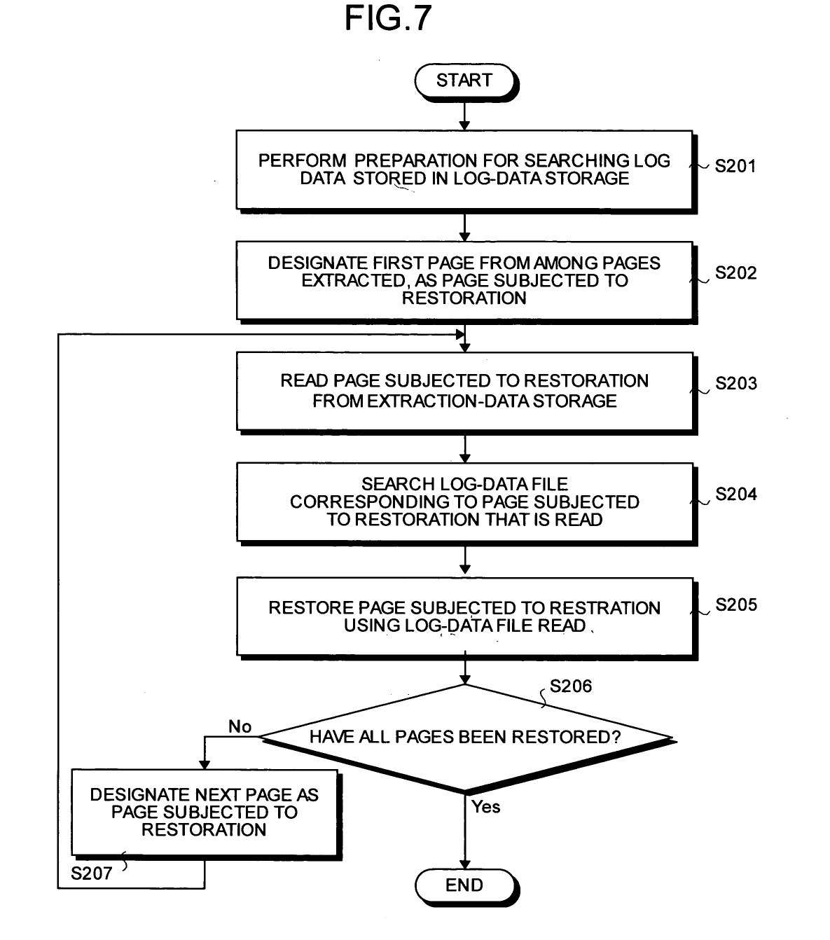

Next, an operation of restoring executed by the data restoring section 18 is described in detail with reference to FIG. 7. When the data restoring section 18 restores the data, preparation for searching the updated log data stored in the log-data storage is performed (step S201). This search preparation is an operation of rearranging the updated log data according to the corresponding page. Because the log-data acquisition section 15 monitors the operation of the updating processor 11 and acquires the updated log data at any time, the updated log data is normally acquired as data of time series. On the other hand, the restoring is in units of pages. Therefore, by rearranging in advance the updated log data according to the corresponding page, the search of the updated log data corresponding to each page can be performed at a high speed.

Upon completion of the search preparation (step S201), the data restoring section 18 designates a first page from among the pages extracted as a page subjected to restoration (step S202). Then, the data restoring section 18 reads the page subjected to restoration from the extraction-data storage 16 (step S203). Further, the data restoring section 18 searches from the log-data storage 17, updated log data file corresponding to the page subjected to restoration (step S204). The data restoring section 18 restores the page subjected to restoration that is read using the log-data file searched (step S205).

Further, the data restoring section 18 determines whether all pages of the data to be extracted are restored (step S206). If any page is not restored (No at step S206), the data restoring section 18 designates the next page as the page subjected to restoration (step S207), and the process returns to step S203. Thus, all the pages extracted are restored one by one by searching the corresponding log-data for each page, and when all the pages are restored (Yes at step S206), the restoring ends.

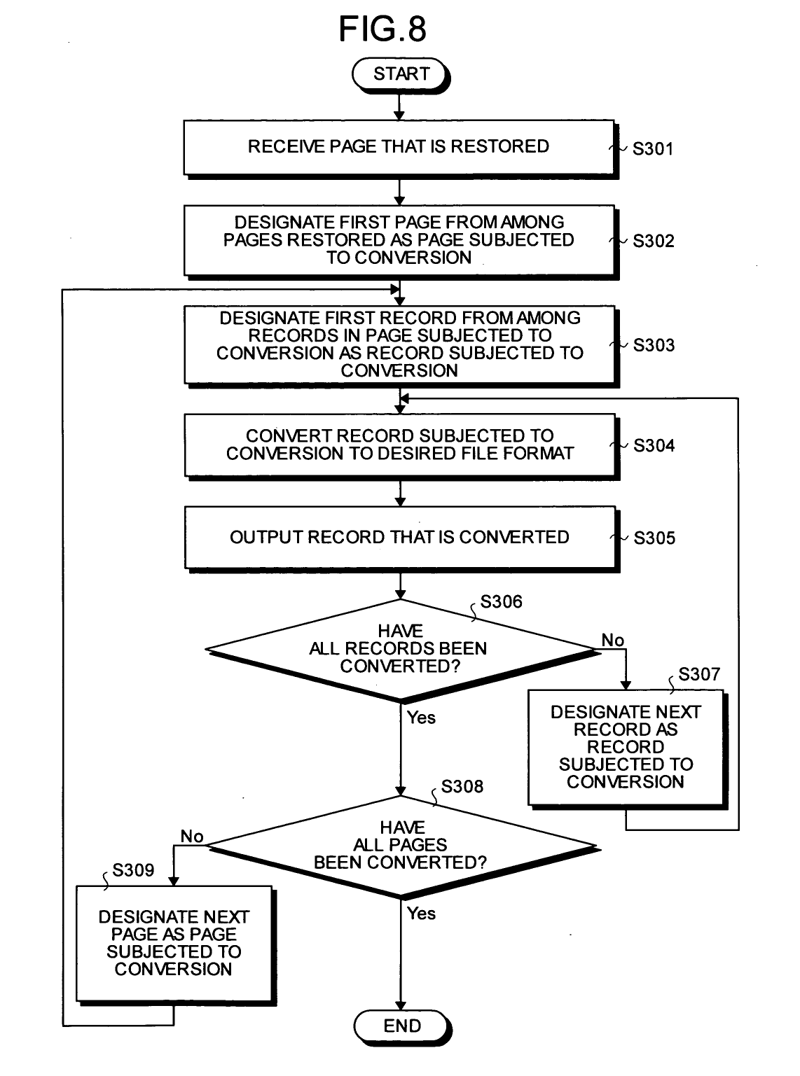

Next, an operation of conversion of a data format by the format converter 19 is described in detail with reference to FIG. 8. To start with, the format converter 19 receives data that is restored by the data restoring section 18 (step S301), and designates a first page from among the pages restored as a page subjected to conversion (step S302).

Further, the format converter 19 designates a first record from among records in the page subjected to conversion as a record subjected to conversion (step S303). The format converter 19 converts the record subjected to conversion to a desired file format (step S304), and outputs the record converted (step S305).

The format converter 19 determines whether all records in the page subjected to conversion are converted (step S306). If any record is not converted yet (No at step S306), the format converter 19 designates the next record as the record subjected to conversion (step S307), and the process returns to step S304.

On the other hand, if all the records in the page subjected to conversion are converted (Yes at step S306), the format converter 19 determines if all the pages have been converted (step S308). If any page is yet to be converted (No at step S308), the format converter 19 designates the next page as the page subjected to conversion (step S309), and the process returns to step S303. Thus, when all the pages restored have undergone format conversion one by one (Yes at step S308), the conversion of data format ends.

As described above, in the data extractor 1 according to the embodiments, for extracting the data constellation 21 from the database 2, the process exclusion is acquired only for the page that is being extracted, and the other pages can be accessed freely. Thus, the data constellation 21 can be extracted without decrease in the update response time.

Moreover, if the database is updated during the data extraction, the updated contents are stored as the updated log data, and the contents of the data extracted using the updated log data are restored to values at the time of start of data extraction. Therefore, mismatching of the contents of data can be prevented, and a value of each data at the time of start of data extraction can be obtained.

Further, upon starting acquisition of the updated log data at the time of start of data extraction, the data extractor 1 ends the acquisition of the updated log data for the page for which the extraction is complete, and performs data extraction only for a page that is not extracted, thereby reducing the capacity of the updated log data.

Because the database buffer used for input-output of the database and the buffer memory for extraction 12a are provided independently, even if a large amount of memory capacity is used by the extraction, the memory capacity for updating is secured, and the decrease in the update process speed is avoided.

Realizing the updating processor 11 and the extraction processor 12 as independent processors can secure the process capacity used for the updating, and avoids the decrease in the process speed during updating.

In the embodiments mentioned so far, although the updated log data acquired is used only for restoring the page image, the updated log data may also be used for recovery of the database. In this case, it is not necessary to acquire the log-data uniquely for restoration, thereby enabling to reduce cost of creating log-data of a CPU. While using the same log-data for restoration and recovery, it is necessary to continue acquisition of the updated log data even for a page for which the extraction is completed.

Moreover, in the embodiments mentioned so far, a data extractor suitable particularly for the method of data extraction is described. However, functions described in the embodiments may be realized by software, as a computer program for data extraction that can be run on any computer terminal.

Thus, according to the data extractor and the method of data extraction of the present invention, data extraction can be performed at any point of time.

Furthermore, data extraction can be performed without decreasing the update response time.

Moreover, data extraction can be performed without using excessive storage area of update history, and with a simple structure.

Furthermore, the update response time is secured even if the data extraction is being performed at the same time.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A method of data extraction comprising:
reading successively a plurality of data stored in a database;
acquiring update contents of the data as update history, if there is an update of the data in the database during a period from a start of the reading to an end of the reading; and
overwriting contents of the plurality of the data read with the contents at a time of the start of the reading, based on the update history acquired.

2. The method according to claim 1, further comprising:
providing exclusive control including inhibiting updating of the data that is being read, and allowing updating of the data already read and the data yet to be read, from among the plurality of data subjected to the reading.

3. The method according to claim 2, wherein
the acquiring includes ending the update history acquiring of that data for which the reading is complete, from among the plurality of data subjected to the reading.

4. A data extractor that successively reads a plurality of data stored in a database, comprising:
an update history acquiring unit that acquires update contents of the data as update history, if there is an update of the data in the database during a period from a start of reading of the data to an end of reading of the data; and
an overwriting unit that overwrites contents of the plurality of the data read with the contents at a time of the start of the reading of the data, based on the update history acquired.

5. The data extractor according to claim 4, further comprising:
an exclusive control unit that provides exclusive control to inhibit updating of the data that is being read, and to allow updating of the data already read and the data yet to be read, from among the plurality of data subjected to the reading.

6. The data extractor according to claim 5, wherein
the update history acquiring unit ends acquisition of the update history of that data that has been read, from among the plurality of data subjected to the reading.

7. The data extractor according to claim 4, wherein
an updating processor that updates the plurality of data stored in the database, and an extraction processor that performs the reading of the data, are provided as independent processors.
